(19) United States
(12) Patent Application Publication
(10) Pub. No.: US 2022/0041851 A1
(43) Pub. Date: Feb. 10, 2022

(54) WATER SOLUBLE & DEGRADABLE ELASTOMERIC COMPOSITIONS AND METHOD FOR MAKING THEREOF

(71) Applicants: Kenneth Wyatt Richards, Minnetonka, MN (US); Leeland Glenn Kinnell, Newport, MN (US); David J. Benson, Eagan, MN (US)

(72) Inventors: Kenneth Wyatt Richards, Minnetonka, MN (US); Leeland Glenn Kinnell, Newport, MN (US); David J. Benson, Eagan, MN (US)

(21) Appl. No.: 17/395,802

(22) Filed: Aug. 6, 2021

Related U.S. Application Data
(60) Provisional application No. 63/062,416, filed on Aug. 6, 2020.

(51) Int. Cl. C08L 31/04; C08L 29/04; C08L 23/08; C08K 5/053

(52) U.S. Cl. CPC C08L 31/04; C08L 29/04; C08L 2201/06; C08K 5/053; C08L 23/0853

(57) ABSTRACT

Embodiments disclosed herein relate generally to compositions having water soluble and/or degradable and elastomeric properties.

### CROSS-REFERENCE TO RELATED APPLICATION

This application claims the benefit of U.S. Provisional Application Ser. No. 63/062,416, filed Aug. 6, 2020, the disclosure of which is hereby incorporated by reference in its entirety.

### TECHNICAL FIELD

The present disclosure relates generally to compositions having water soluble and/or degradable and elastomeric properties. More specifically, the embodiments disclosed herein relate to soluble and degradable elastomeric polymeric compositions, the control of such solubility, and degradation and the method of making such materials and in some cases, delivery systems.

### BACKGROUND

Many products are desired to be biodegradable. If the entire product, including all the elements are not biodegradable, the product cannot be said to be fully biodegradable and cannot be composted. For example, pollution of the environment by petroleum-based elastomeric products, for example, gloves, be they made of nitrile, rubber, PVC, polypropylene, and similar materials do not degrade in the landfill and have long degradation half-lives.

It is desirable to have a compound that is biocompatible and/or biodegradable, but also has strength and/or flexibility properties. Improvements in biodegradable compounds are desired. There is a need in the market for materials that address the single and limited use items requiring elastomeric properties that degrade in a timely manner and that do not have adverse effect on the environment.

### SUMMARY

The following summary is made by way of example and not by way of limitation. It is merely provided to aid the reader in understanding some of the aspects of the inventive features.

In one embodiment, a degradable-elastomeric composition is described herein.

In another embodiment, a degradable-elastomeric composition comprises polyvinyl acetate (PVA) and/or polyvinyl alcohol (PVOH) compounded with glycol.

In yet another embodiment, a degradable-elastomeric composition comprises a shear-mixed Elmer's Glue® with glycol.

In yet another embodiment, a degradable-elastomeric composition comprises ethylene-vinyl acetate (EVA) compounded with glycol.

### DETAILED DESCRIPTION

These embodiments are described in sufficient detail to enable those skilled in the art to practice the inventive features, and it is to be understood that other embodiments may be utilized and mechanical changes may be made without departing from the spirit and scope of the present disclosure. The following detailed description is, therefore, not to be taken in a limiting sense, and the scope of the present inventive features are defined only by the claims and equivalents thereof.

Embodiments disclosed herein relate generally to soluble and degradable polymers. Specifically, embodiments disclosed herein relate to a soluble and degradable elastomeric compositions and methods of making such compositions.

The term “polymer” as used herein is defined as any macromolecule or system of macromolecules commonly referred to as “polymeric,” and includes, without limitation, naturally occurring and synthetically-produced macromolecules, repeating and non-repeating chain macromolecules, and soluble and degradable biopolymers and copolymers.

The term “degradable polymers” is defined as a degradable polymer, or a blend of more than one degradable polymer, that degrade under biological, chemical and environmental or a combination of conditions that render the polymer to carbon. Degradable polymers can include, but are not limited to, polylactic acid (PLA), polyhydroxyalkanoic acid (PHA), polyhydroxybutyrate (PHB), polyglycolic acid (PGA), and other polyesters including such as, for example, polybutylene succinate (PBS), polybutylene adipate terephthalate (PBAT), and other similar components. PHA may be used interchangeably with degradable polymer within this disclosure. Polylactic acid and polyglycolic acid are examples of PHAs. Additional examples of PHAs include polyhydroxybutyrate, polyhydroxyvalerate, and polyhydroxyhexanoate and their copolymers, such as, for example, poly(lactic-co-glycolic acid), poly(hydroxybutyrate-co-hydroxyvalerate), etc. PHAs have the general structure.

The term “soluble” with reference to this disclosure refers to compositions that are soluble in or when exposed to water or a degrees of moisture.

The term “input” or “inputs” as used herein is defined as any soluble or degradable polymer, chemical, compound, blend, composite, or substance that is an additive or component utilized to produce the soluble or degradable elastomeric compositions. The input or inputs may include at least soluble polymers, degradable biopolymers, additives for cross linking, UV curing, foaming, fillers, compatibilizers, or processing aids.

The term compound or compound refers to a process utilizing a twin screw co-rotating compounder that may utilize heat, mix, blend, impart shear, and convey a composition in various form factors such as strand pelletized, underwater pelletized, a liquid, or paste as a few examples.

The term “shear mixed” refers to the use of a vessel in which the inputs are added when appropriate and incorporates a mixing system that can impart the required shear mixing to the material for homogenous incorporation of such inputs and also incorporates controlled temperature that can be imparted to the material within the vessel as necessary for the production of the composition.

The embodiments disclosed herein relate generally to elastomeric compositions that have controlled degradation solubility properties. Specifically, the embodiments disclosed herein relate to elastomeric compositions wherein controlled degradation is desired, solubility of elastomeric compositions, and methods for making said compositions, uses of said compositions, and delivery methods of said compositions.

The embodiments described herein allow for the utilization of various inputs for the making of controlled degradation of the elastomeric compositions to achieve the application functionality and conversion to a product.

The embodiments described herein allow for the utilization of various inputs for the making of controlled solubility of the elastomeric compositions to achieve the application functionality and conversion to a product.

In some embodiments, a degradable elastomeric composition is provided that includes degradable polymeric inputs. In some embodiments, a soluble-elastomeric composition is provided that includes soluble inputs.

In some embodiments, a degradable elastomeric composition is provided that includes one or more degradable polymeric inputs and at least one stabilizer to control the degradation. In some embodiments, a degradable elastomeric composition is provided that includes one or more degradable polymeric inputs that are cross-linked to provide further control of the degradation and to provide material stability for an application.

In some embodiments, a degradable elastomeric composition is provided that includes one or more degradable polymeric input and at least one additive to assist and reduce the cure time of such composition. The at least one additive may or may not be cross linked and contain stabilizers where the application requires such.

In an embodiment, a composition includes polyvinyl acetate (PVA) and/or polyvinyl alcohol (PVOH) compounded with glycol. In an example, the composition includes 70% to 95% by weight PVA/PVOH and 5% to 30% by weight glycol.

In another embodiment, a composition includes PVA/PVOH compounds with glycol and an additional component. In an example, a composition is composed of 12% to 20% by weight PVA/PVOH and 2% to 5% by weight glycol and shear mixed with 75% to 86% by weight isopropyl alcohol (IPA). IPA can be used to control viscosity and drying time for use as a soluble polymeric delivery system. Further, IPA can be used as an antimicrobial and/or antiviral substance to adhere and dry on a surface that may be delivered by aerosol or spraying.

In another example, a PVA/PVOH composition is compounded with glycol composed of 70% to 85% by weight PVA/PVOH and 7% to 15% by weight glycol and shear mixed with 5% to 25% by weight IPA. The IPA controls viscosity and drying time for a thin coat material that may include, for example, one-time use gloves that are soluble over time.

Another embodiment includes a PVA/PVOH composition compounded with one or more of polybutylene adipate terephthalate (PBAT), PHA, PBS, and/or other biodegradable polymers to control degradation and elastomeric properties. Further, PHA, PBS, or another biodegradable polymer may be used to control degradation and elastomeric properties.

In another embodiment, a PVA/PVOH compound is crosslinked with a PBAT, PHA, PBS, and/or other biodegradable polymers. The use of a crosslinking component increases the toughness of the degradable-elastomeric composition and increases the degradation time.

In an embodiment, a PVA/PVOH composition is compounded with one or more of PBAT, PHA, PBS, and/or other biodegradable polymers, and addition of a UV curing additive to reduce the cure time of the elastomeric composition.

In an embodiment, a PVA/PVOH is compounded and crosslinked with PBA, PHA, PBS and/or other biodegradable polymers, and addition of a UV curing additive to reduce the cure time of the elastomeric composition.

In an embodiment, a composition includes a shear mixed Elmer's Glue® with glycol. Elmer's Glue® is polyvinyl acetate (PVA, PVAc, poly(ethenyl ethanoate)). In an example, a composition is composed of 70% to 95% by weight Elmer's Glue® and 5% to 30% by weight glycol.

In one embodiment, Elmer's Glue® is shear mixed with glycol. The composition is composed of 12% to 20% by weight Elmer's Glue® and 2% to 5% by weight glycol, and followed by shear mixing with 75% to 86% by weight IPA. The IPA is used for purpose of controlling viscosity and drying time, and for use as a soluble polymeric delivery system of, for example, an antimicrobial and/or anti-viral substance to adhere and dry on the surface that may be delivered by aerosol or spraying.

In one embodiment, Elmers Glue® is shear mixed with glycol composed of 70% to 85% by weight Elmer's glue, 7% to 15% by weight glycol, and followed by shear mixing with 5% to 25% by weight IPA. The IPA controls viscosity and drying time for a thin coat material that may include, by example, one-time use gloves that are soluble over time.

In another embodiment, Elmer's Glue® is shear mixed with glycol composed of 12% to 20% by weight Elmer's Glue® and 2% to 5% by weight glycol and followed by shear mixing with 75% to 86% by weight IPA for purpose of controlling viscosity and drying time. Further, the IPA is used as a soluble polymeric delivery system of, for example, an antimicrobial and/or anti-viral substance to adhere and dry on the surface that may be delivered by aerosol or spraying.

In one embodiment, Elmer's Glue® is shear mixed with glycol composed of 70% to 85% by weight Elmer's Glue®, 7% to 15% by weight glycol, and followed by shear mixing with 5% to 25% by weight IPA to control viscosity and drying time for a thin coat material that may include, by example, one time use gloves that are soluble over time.

In another embodiment, Elmer's Glue® is crosslinked with a PBAT, PHA, PBS, and/or other biodegradable polymer. The use of a crosslinker increases the toughness of the solubility, degradation of the elastomeric composition, and increases the degradation time.

In one embodiment, Elmer's Glue® is compounded with glycol and crosslinked with a PBAT, PHA, PBS, and/or other biodegradable polymer with the use of a crosslinker to increase the toughness of the solubility, degradation of the elastomeric composition, and increase the degradation time.

In one embodiment, Elmer's Glue® is compounded and crosslinked with a PBAT, PHA, PBS, and/or other biodegradable polymer, and addition of UV curing additive to reduce the cure time of the elastomeric composition.

In one embodiment, Elmer's Glue® is compounded with glycol and crosslinked with a PBAT, PHA, PBS, and/or other biodegradable polymer, and addition of a UV curing additive to reduce the cure time of the elastomeric composition.

In an embodiment, a composition includes ethylene-vinyl acetate (EVA) compounded with glycol. The composition may include 70% to 95% by weight EAV and 5% to 30% by weight glycol.

In one embodiment, EVA is compounded with one or more of PBAT, PHA, PBS, and/or other biodegradable polymers to control degradation and elastomeric properties.

In one embodiment, EVA is crosslinked with a PBAT, PHA, PBS, and/or other biodegradable polymer with the use of a crosslinker.

In one embodiment, EVA is compounded with one or more of PBAT, PHA, PBS, and/or other biodegradable polymers, and addition of a UV curing additive to reduce the cure time of the elastomeric composition.

In another embodiment, EVA is compounded and crosslinked with a PBAT, PHA, PBS, and/or other biodegradable polymer, and addition of aa UV curing additive to reduce the cure time of the elastomeric composition.

The above specification, examples, and data provide a complete description of the manufacture and use of the composition of embodiments of the inventive aspects. Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the disclosure. Therefore, it is manifestly intended that the inventive features be limited only by the claims and the equivalents thereof.

1. A degradable-elastomeric composition as described herein.

2. The composition of claim 1 comprising a polymeric input.

3. The composition of claim 1 comprising a soluble input.

4. The composition of claim 1 comprising at least one degradable polymeric input.

5. The composition of claim 4 further comprising at least one stabilizer.

6. The composition of any one of claims 4-5, wherein the at least one degradable polymeric compound is cross-linked.

7. The composition of any one of claims 4-6 further comprising at least one additive.

8. The composition of claim 7, wherein the at least one additive is cross-linked.

9. The composition of claim 7, wherein the at least one additive is a stabilizer.

10. The composition of any one of claims 1-4, wherein the input is any soluble or degradable polymer, chemical, compound, blend, composite, or substance that is an additive or component utilized to produce the soluble or degradable elastomeric compositions.

11. The composition of any one of claims 1-4, wherein the input includes at least soluble polymers, degradable biopolymers, additives for cross linking, UV curing, foaming, fillers, compatibilizers, or processing aids.

12. A degradable-elastomeric composition comprising polyvinyl acetate (PVA) and/or polyvinyl alcohol (PVOH) compounded with glycol.

13. A degradable-elastomeric composition comprising a shear-mixed Elmer's Glue® with glycol.

14. A degradable-elastomeric composition comprising ethylene-vinyl acetate (EVA) compounded with glycol.
